(19) United States
(12) Patent Application Publication
(10) Pub. No.: US 2009/0319793 A1
(43) Pub. Date: Dec. 24, 2009

(54) PORTABLE DEVICE FOR USE IN ESTABLISHING TRUST

(76) Inventors: John Joseph Zic, New South Wales (AU); Surya Nepal, New South Wales (AU)

Correspondence Address: BRINKS HOFER GILSON & LIONE, P.O. BOX 10395, CHICAGO, IL, 60610, US

(21) Appl. No.: 12/440,686

(22) PCT Filed: Sep. 10, 2007
(86) PCT No.: PCT/AU2007/001337

§ 371 Date: Aug. 19, 2009

(30) Foreign Application Priority Data
Sep. 11, 2006 (AU) 2006905001

(51) Int. Cl. H04L 9/00; G06F 21/00

(52) U.S. Cl. 713/172; 713/175

(57) ABSTRACT

A portable device for use in establishing trust including a communications module for communicating with a host machine; embedded trusted data; a virtual machine module for instantiating a virtual machine on the host machine; and a security module for including a secure application in the virtual machine to perform an attestation process using the embedded trust data to authenticate the host machine.

### FIELD

The present invention relates to a portable device for use in establishing trust.

### BACKGROUND

Communications networks, such as the Internet, provide users with considerable flexibility as to the manner in which they can connect to the networks. A user may establish a connection from disparate locations using a number of different devices, e.g. a personal computer, a mobile or cellular phone, or a personal digital assistant (PDA). All these devices are essentially client machines or terminals constituting computers that connect to a network resource. Establishing a client/server link to the resource normally requires some level of authentication that may be performed automatically by the connecting machines or require some additional data from the user of the client machine. For secure or confidential resources, however, the link for the client machine must be authenticated to a level where the machine can be considered a trusted machine before access to the resource is allowed. A trusted machine is normally one that is considered to meet predetermined security, usability and verification criteria. A perennial problem is how to best establish that a remote client machine is trusted.

A number of authentication or attestation mechanisms have been developed in attempt to established that a machine is trusted. For example, an agent working for a company may be issued a digital certificate against which the agent is authenticated when logging in from a remote untrusted machine. The certificate can be used to establish the level of trust between the machine used by the agent and a server on which secure resources of the company are available. Once the client/server link has been authenticated using the certificate, customised applications or confidential client data can be available for use by the agent on the client machine. Yet a number of problems exist with this approach.

Firstly, the certificate is bound to a specific client machine making it difficult for the agent to move to another machine. It will be impossible, for example, to use another machine to access information using secure communication tunnels if the agent tries to use the certificate issued to the initial machine. Secondly, when the agent uses the certificate on an untrusted host machine, the security of the certificate is vulnerable to compromise by malicious software, e.g. malware, that may be running on that host machine. Thirdly, it is possible for the certificate details to be compromised in other ways by theft or loss.

Although old certificates can be periodically revoked and reissued, this is a complex system to manage, particularly with a large number of agents. Finally, if the agent is using an untrusted host machine then any downloaded secure applications or confidential data will be vulnerable to attack.

Accordingly, it is desired to address the above or at least provide a useful alternative.

### SUMMARY

In accordance with the present invention there is provided a portable device for use in establishing trust including:
a communications module for communicating with a host machine; embedded trusted data;
a virtual machine module for instantiating a virtual machine on the host machine; and
a security module for including a secure application in said virtual machine to perform an attestation process using said embedded trust data to authenticate said host machine.

The present invention also provides a method of producing a portable device for use in establishing trust, including:
generating an endorsement cryptographic public/private key pair;
generating an endorsement credential digital certificate using the public key of the key pair and credential data; and
generating an endorsement credential digital signature using the private key of the pair and the endorsement credential certificate;
said endorsement key pair, endorsement credential digital certificate, digital signature and credential data being trusted data for storage in said device.

The present invention also provides a process for establishing trust between a host machine and a remote machine, including:
instantiating a virtual machine on the host machine using a memory device with embedded trust data, the virtual machine including a secure application for communicating with the remote machine;
performing an attestation process with the remote machine, to establish said trust, using the secure application and the trust data.

The present invention also provides a portable device for use in establishing trust, the device including:
a communications module for communicating with an untrusted computing system;
embedded trusted data;
a virtual machine module for instantiating a virtual machine on the untrusted computing system; and
a security module for including a secure application in said virtual machine to perform an attestation process using said embedded trust data to establish trust.

### DESCRIPTION OF THE DRAWINGS

Preferred embodiments of the present invention are hereinafter described, by way of example only, with reference to the accompanying drawings wherein:

FIG. 1 is a schematic diagram of a preferred embodiment of a portable trusted device, a host machine, and a remote machine;

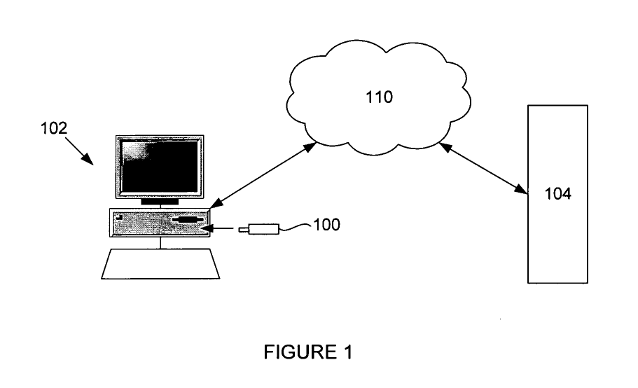

FIG. 2 is a block diagram of the portable trusted device;

FIG. 3 is an architecture diagram of the device connected to a host machine;

FIG. 4 is layer diagram of the software components of the host machine, including a virtual machine instantiated by the device;

FIG. 5 is a flow diagram of a trusted data generation and embedding process for the portable trusted device;

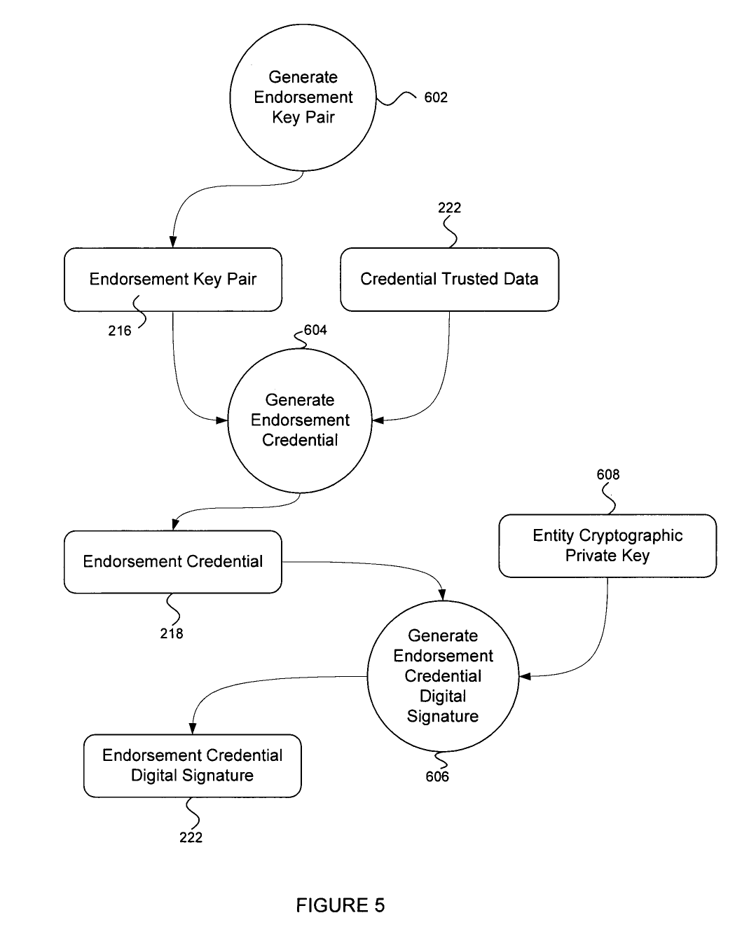

FIG. 6 is a block diagram of a remote machine;

FIG. 7 is a flow diagram of a communication process of the trusted device;

FIG. 8 is a flow diagram of an attestation process performed by the trusted device and a remote machine; and

FIG. 9 is a diagram of data flow in the attestation process of FIG. 8.

### DETAILED DESCRIPTION OF PREFERRED EMBODIMENTS

A trust extension device (TED) 100, as shown in the Figures, is a portable device for trusted communication for connection to a host machine 102. The TED 100 is constructed with embedded trusted data and instruction code that allows an untrusted host computing system or machine 102 to be authenticated or attested by a remote machine 104 over a communications network 110. After the TED 100 has been connected to the host machine 102, an attestation procedure is executed which enables the remote machine 104, e.g. server, to consider the host machine 102 trusted.

The host machine 102 is for example a commercially available personal computer (PC), such as produced by Lenovo Corporation, running the Windows XP operating system (OS) manufactured by Microsoft Corporation. In alternate embodiments, the host machine 102 may be a PC running an alternate operating system (e.g. Linux or Mac OS X), or a personal computing device, such as a PDA or mobile or cellular telephone running a mobile OS such as Symbian or Windows Mobile.

The remote machine 104 is adapted to communicate with the host machine 102 over the communications network 110, and includes components for carrying out secure communications to provide access to confidential or secure resources for the host machine 102 once considered trusted. The remote machine 104 is for example a commercially available computer server, such as produced by Dell Corporation, running communications software, such as Apache, etc. The communications network 110 is for example the Internet, a wireless network, or a mobile phone network.

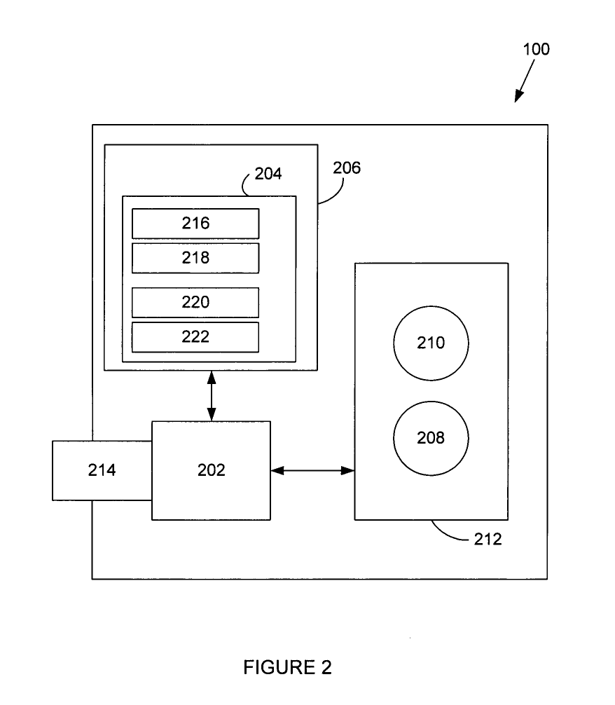

The TED 100, as shown in FIG. 2, is in the form of a USB memory key, which is convenient to carry on the user's person, and convenient to connect to the host machine 102. The TED 100 includes: a communications module 202 for communicating with the host machine 102; embedded trusted data 204 in a trusted platform module (TPM) 206; and a virtual machine module 208 and a security module 210 stored in a memory circuit 212.

The communications module 202 enables communication with the host machine 102 via a USB protocol and includes a USB port 214 to connect to a USB port on the host machine 102. In alternative embodiments, the communications module 202 may include a Firewire port for communicating via a Firewire protocol, or a standard serial or parallel port for serial or parallel communications, or a wireless transceiver to enable wireless communication with the host machine 102.

The memory circuit 212 is a storage area that includes read-only flash type memory. The embedded trusted data 204 is used for authentication and attestation of the TED 100. The embedded trusted data 204 includes an endorsement key pair 216, an endorsement credential 218, an endorsement credential digital signature 220, and credential trusted data 222. The TPM 206 is a hardware module manufactured by Infineon Technologies AG (Munich, Germany). The Infineon TPM may be either Version 1.1 or Version 1.2. In alternative embodiments, the TPM 206 may be a module supplied by National Semiconductor (Santa Clara, Calif., USA), Amtel Systems Corporations (Chester Springs, Pa., USA), or other manufacturers.

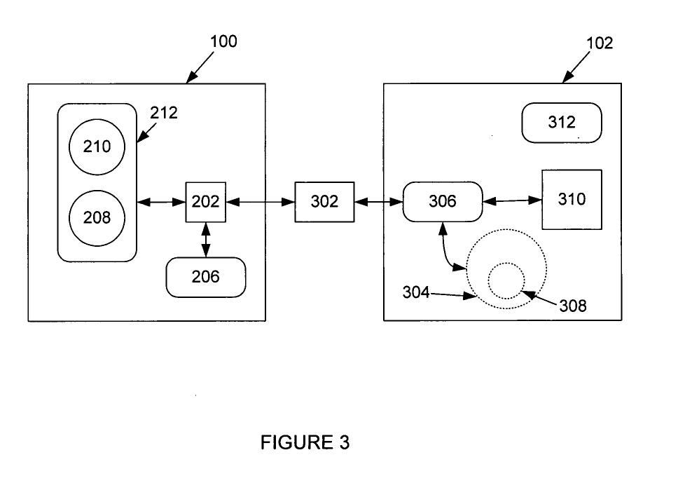

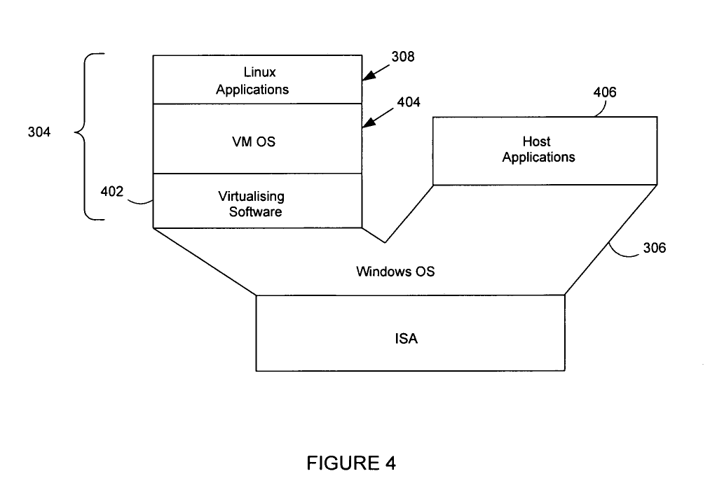

The TED 100 and host machine 102 connect via a USB connection 302, shown in FIG. 3, through which the virtual machine module 208 of the TED 100 instantiates a virtual machine 304 on the host machine's operating system 306. The virtual machine 304 is a full system virtual machine operating on top of the host's operating system 306, as shown in FIG. 4. Once the virtual machine 304 is instantiated on the host machine 102, the security module 210 in the TED 100 installs a secure application 308 in the virtual machine 304. Once running, the secure application 308 communicates via a network connector 310 on the host machine 102 to the remote machine 104. The secure application 308 uses the embedded trust data 204 in the TPM 206 to attest and authenticate transactions with the remote machine 104. When the secure application 308 is running, any secure communications between the host machine 102 and the remote machine 104 are conducted using the embedded trust data 204 in the TPM 206 of the TED 100. This also avoids any conflict with another TPM 312 that may reside on the host machine 102.

The host machine 102 includes a device driver for the TED 100 and application program interfaces (APIs) to access the features of the TPM 206. The APIs are from the TrouSers TSS project (Version 0.2.7) and jTss Wrapper (Version 0.2.1). In alternative embodiments, the device driver may either be supplied by the manufacturer or owner of the TPM 206, a generic device driver included in the operating system of the host machine 102, or supplied by a third party supplier. The APIs may be supplied by the manufacturer of the TPM 206, or from the manufacturer of an operating system, or from a third party.

The virtual machine 304 runs as a full system virtual machine, as shown in FIG. 4, which means that the virtualising software 402 runs on the host operating system 306. As a result, the host machine 102 may continue to run host applications 406 at the same time as the virtual machine 304. Furthermore, the virtual machine 304 does not require the host machine 102 to be rebooted when the virtual machine 304 is instantiated. The virtual machine 304 is in the form of a QEMU open source processor emulator (Version 8.2.0) for Microsoft's Windows XP. The QEMU virtual machine is described in a publication by Fabrice Bellard entitled ‘QEMU, A Fast Portable Dynamic Translator’ (Proceedings of the 2005 USENIX Annual Technical Conference). QEMU is available at http://bellard.org/qemu. The QEMU virtualising software 402 enables a virtual machine operating system 404 to be installed in the virtual machine 304 in the form of a Linux operating system, i.e. a customised version of the Ubuntu 6.06 I386 GNU/Linux distribution.

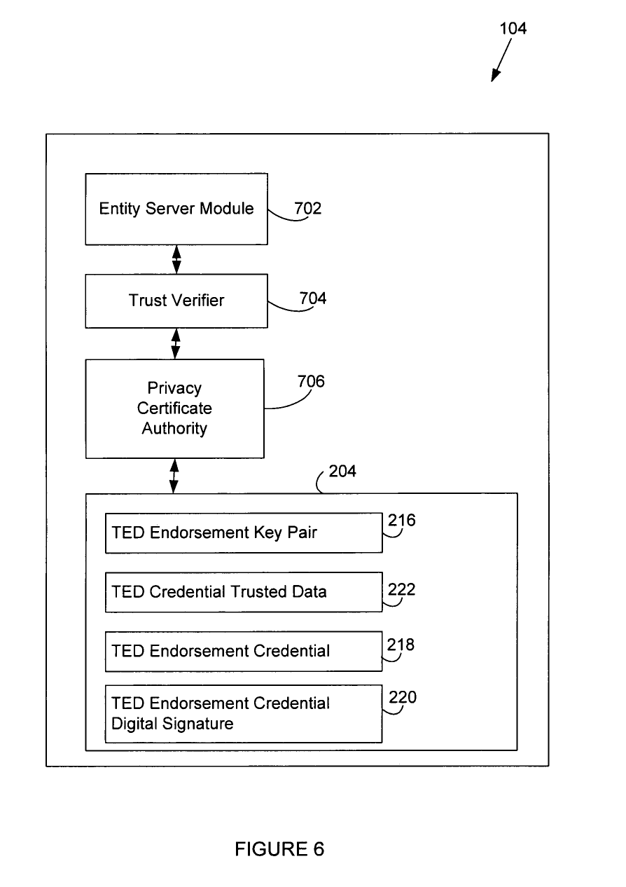

The TPM 206 is a secure hardware repository for cryptographic keys used in secure communications. These keys are in the embedded trusted data 204. The embedded trusted data 204 is embedded into the TPM 206 by the manufacturer of the TED 100. The manufacturer is authorised by an entity (such as a government agency or bank) that supplies the keys for the TED 100. The entity generates the components of the trusted data 204 using a trusted data generation process, as shown in FIG. 6, which may be executed on the remote machine 104 or another machine, eg a secure machine at the entity's or manufacturer's premises. At step 602, the entity generates an endorsement key pair 216, which is a public/private key pair. The endorsement key pair 216 is unique to each TPM 206 and is embedded into the TPM 206 during the manufacturing process. The private component of the endorsement key pair 216 is never exposed outside the TPM 206. The public component of the endorsement key pair 216 is available outside the TPM 206 in the endorsement credential 218. At step 604, the endorsement credential 218 is generated using the public component of the endorsement key pair 216 and credential trusted data 222 unique to each TPM 206. The endorsement credential 218 is a digital certificate. The purpose of the endorsement credential 218 is to provide attestation that a particular TPM 206 is genuine and that the private component of the endorsement key pair 216 has not been compromised. At step 606, an endorsement credential digital signature 220 is generated based on the endorsement credential 218 of the TPM 206 and the entity's cryptographic private key 608. The credential trusted data 222, the endorsement key pair 216, the endorsement credential 218 and the endorsement credential digital signature 220 are embedded into the TPM 206 as the trusted data 204 during manufacture.

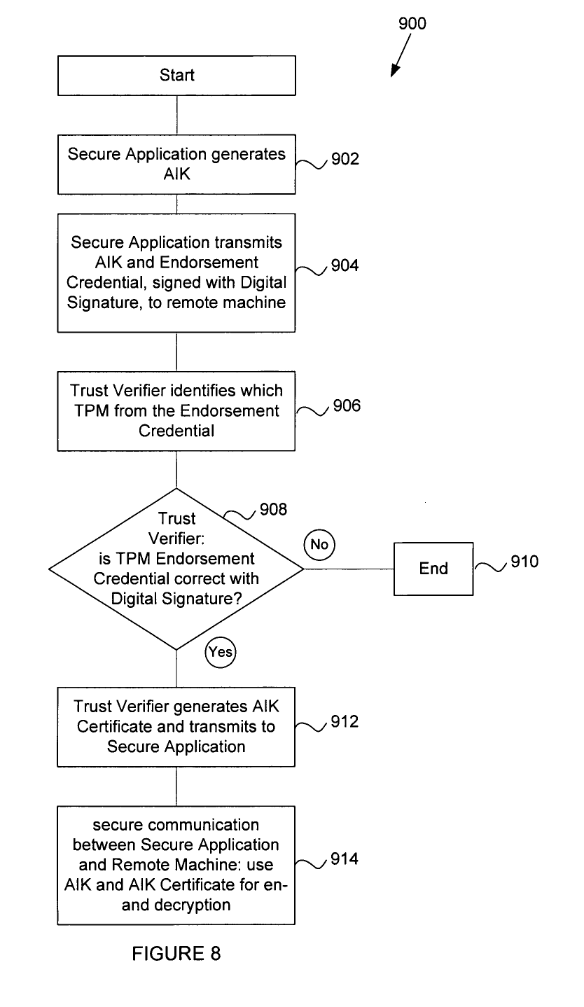

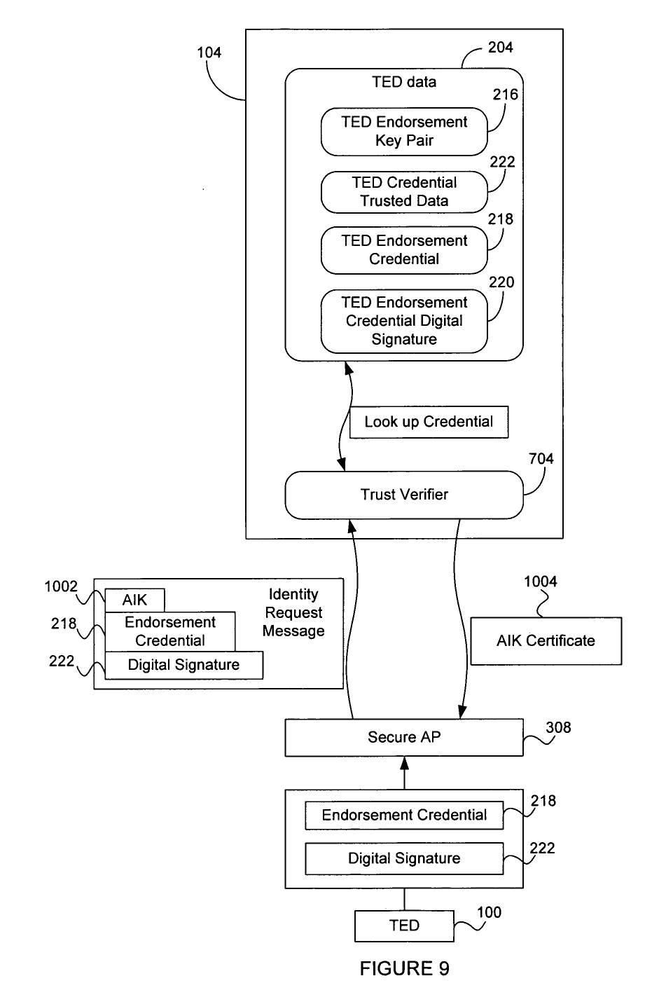

Further to storing the embedded trusted data 204, the TPM 206 is used to generate a further public/private key pair used in communications, i.e. an Attestation Identity Key (AIK) 1002 described with reference to FIGS. 8 and 9 below. The TPM 206 is also able to generate one or more identity request messages, to load one or more AIK certificates 1004, and generate and store cryptographic hashes, as used in secure communications with the remote machine 104.

After manufacture of the TPM 206, a copy of the embedded trusted data 204 is also stored in the remote machine 104, as shown in FIG. 6. The remote machine 104 further includes an application server module 702 for communicating over the network 110, a trust verifier 704 and an entity privacy certificate authority 706 used for attestation of the TED 100 and subsequent secure communications with the TED 100. As will be understood, the entity may choose to distribute the components 702, 704, 706 over two or more machines.

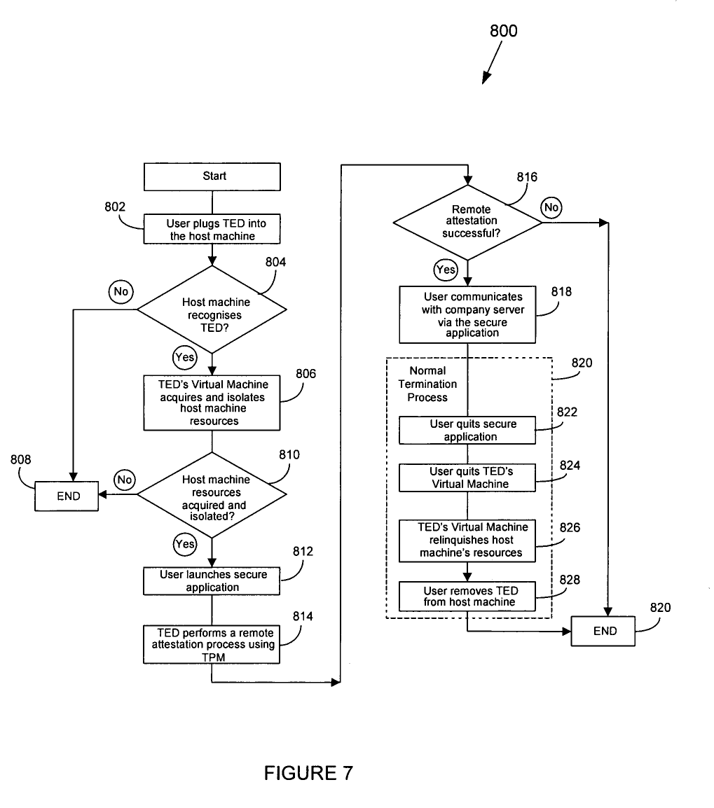

In a typical usage scenario a user associated with an entity, e.g. a tax agent working on behalf of a taxation service entity, travels to a remote premises and plugs the user's TED 100 into the host machine 102 located at the remote premises as shown in FIG. 7 (step 802). The host machine 102 is untrusted and may contain a computer virus. If the host machine 102 recognises the TED 100 at step 804, the TED 100 instantiates the virtual machine 304 on the host machine 102, and the virtual machine 304 acquires and isolates the computing and interface resources of the host machine 102 (step 806). If the host machine 102 does not recognise the TED 100, e.g. if software drivers are not installed, the usage process 800 ends at step 808. Similarly, if the virtual machine 304 is unable to acquire and isolate the resources of the host machine 102, e.g if access to a disk drive or memory fails, the usage process will also end at step 808. On the other hand, if the virtual machine 304 successfully acquires and isolates the resources of the host machine 102, the secure application 308 can be launched on the virtual machine 304 at step 812. The TED 100 then attempts to perform an attestation process 900, shown in FIG. 9, at step 814. If the attestation process 900 is successful (step 816) secure communications between the user of the TED 100 and the entity's remote machine 104 can commence at step 818. If the attestation process 900 is not successful at step 816, the usage process ends at step 820. The attestation process 900 may fail if the communications pathway via the network 110 is not available, or if the embedded trusted data 204 is not recognised by the remote machine 104. After communications to access secure resources of the remote machine 104 are completed (step 818), the user follows a normal termination process 820, which includes quitting the secure application 308 (step 822), quitting the virtual machine 304 (step 824), the virtual machine 304 relinquishing the resources of the host machine 102 (step 826) and the user disconnecting the TED 100 from the host machine 102 (step 828). After the normal termination process 820, the communication process 800 finishes at step 820.

The attestation process 900, as shown in FIG. 8, commences by the secure application 308 generating the AIK 1002 (shown in FIG. 9) at step 902. The AIK 1002 is generated on the basis the endorsement certificate 218 and the credential trusted data 222 embedded in the TPM 206. The AIK 1002 and the endorsement credential 218—both signed with the endorsement credential digital signature 220—are sent to the remote machine 104 at step 904. Upon receiving the signed AIK 1002 and endorsement credential 218, the trust verifier 704 in the remote machine 104 identifies the TPM 206 from the transmitted endorsement credential 218 by comparing the transmitted endorsement credential 218 with the stored endorsement credential 218 in the remote machine 104 (step 906). The remote machine 104 also contains a copy of the endorsement credential digital signature 220 and may therefore determine whether the TPM endorsement credential 218 is correct and whether it is signed correctly with the endorsement credential signature 220 of the TED 100 (step 908). If the endorsement credential 218 of the endorsement credential digital signature 220 is not recognised by the remote machine 104, the attestation process 900 ends at step 910; if the credential 218 and signature 220 are recognised and correct, the trust verifier 704 generates an AIK certificate 1004 based on the received AIK 1002 and trust data 204 accessed by the privacy certificate authority 706. The AIK certificate 1004 is transmitted to the secure application 308 at step 912. Once the AIK certificate 1004 has been received, secure communications between the secure application 308 and the remote machine 104 can proceed using the AIK 1002 and AIK certificate 1004 for encryption and decryption (step 914). Both can be used to establish secure communications using TLS, SSL or IPSEC, or data may be simply encrypted, transmitted and decrypted by the machines 102 and 104. The attestation process 900 may be performed on a per-transaction or a per-connection basis. Per-transaction means the secure application 308 performs the attestation process 900 for every operation, or every required transaction communication with the remote machine 104. Per-connection attestation means the attestation process 900 is only performed once during a trusted connection session between the host 102 and the remote machine 104.

The attestation process 900 allows a trust relationship to be established between the user's untrusted host machine 102 and the remote server 104 using cryptographic keys embedded in the TED 100. The attestation process 900 establishes that the TPM 206 is the genuine owner of the embedded trusted data 204, and that the embedded trusted data 204 has not been tampered with. If the TED 100 is lost of stolen, the enterprise that issued the TED 100 is able to revoke the credentials corresponding to the embedded trusted data 204 in that TED 100. The attestation process 900 is performed within a trusted environment 304 instantiated on the host machine 102, and isolated from untrusted components.

Many modifications will be apparent to those skilled in the art without departing from the scope of the present invention as hereinbefore described with reference to the accompanying drawings.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A portable device for use in establishing trust including:
a communications module for communicating with a host machine;
embedded trusted data;
a virtual machine module for instantiating a virtual machine on the host machine; and
a security module for including a secure application in said virtual machine to perform an attestation process using said embedded trust data to authenticate said host machine.

2. The portable device as claimed in claim 1, wherein the embedded trusted data includes an endorsement key pair, an endorsement credential certificate, an endorsement credential digital signature and credential trusted data for the portable device.

3. The portable device as claimed in claim 1, wherein the virtual machine includes virtualising software and said secure application for communicating securely between the host machine and a remote machine.

4. The portable device as claimed in claim 1, wherein the portable device includes a memory circuit for storing said virtual machine module and said security module.

5. The portable device as claimed in claim 1, wherein the communications module for communicating to the host machine includes a communications port.

6. The portable device according to claim 5, wherein the communications port comprises a USB port, a Firewire port, a serial port, a parallel port, an optical transceiver, or a radio transceiver.

7. The portable device according to claim 1, wherein the host machine is connected to the remote machine via a communications network.

8. The portable device according to claim 7, wherein said attestation process is performed by said host machine and said remote machine over the communications network to enable said remote machine to authenticate said host machine on the basis of said embedded trusted data.

9. The portable device according to claim 8 wherein said attestation process enables a trust relationship to be established between an untrusted host machine and said remote machine using the embedded trusted data.

10. The portable device according to claim 9, wherein the attestation process verifies the integrity and ownership of the trusted data by said portable device.

11. The portable device according to claim 10, wherein the attestation process is executed after the portable device has been connected to the host machine, and enables the remote machine to consider the host machine as trusted.

12. The portable device according to claim 11, wherein the secure application enables the remote machine and the host machine to carry out secure communications over the communications network and provides secure access to confidential or secure resources for the host machine once the host machine is considered to be trusted.

13. The portable device according to claim 12, wherein the attestation processes uses a copy of the embedded trusted data accessible by said remote machine to authenticate said host machine.

14. A method of producing a portable device for use in establishing trust, including:
generating an endorsement cryptographic public/private key pair;
generating an endorsement credential digital certificate using the public key of the key pair and credential data;
generating an endorsement credential digital signature using the private key of the pair and the endorsement credential certificate;
said endorsement key pair, endorsement credential digital certificate, digital signature and credential data being trusted data for storage in said portable device;
embedding said trusted data in said portable device which includes a communications module for communicating with a host machine;
storing in said portable device a virtual machine module for instantiating a virtual machine on a host machine; and
storing in said portable device a security module for including a secure application in said virtual machine to perform an attestation process using the embedded trust data to authenticate the host machine.

15. The method as claimed in claim 14, wherein the virtual machine includes virtualising software and said secure application for communicating securely between the host machine and a remote machine.

16. The method as claimed in claim 14, wherein said embedding is in a trusted platform module of said sortable device.

17. The method as claimed in claim 14, wherein the communications module for communicating to the host machine includes a communications port.

18. The method according to claim 17, wherein the communications port comprises a USB port, a Firewire port, a serial port, a parallel port, an optical transceiver, or a radio transceiver.

19. A process for establishing trust between a host machine and a remote machine, including:
instantiating a virtual machine on the host machine using a memory device with embedded trust data, the virtual machine including a secure application for communicating with the remote machine; and
performing an attestation process with the remote machine, to establish said trust, using the secure application and the trust data.

20. The process as claimed in claim 19, including:
sending at least part of the trusted data to said remote machine;
verifying the trust data at said remote machine to establish said trust.

21. The process as claimed in claim 20, including:
generating and sending an attestation key with said at least part of the trust data;
generating an attestation certificate at said remote machine following verification;
sending the certificate to said secure application; and
communicating between said host machine and said remote machine using said attestation key and certificate for encrypted communications.

22. The process as claimed in claim 19, wherein said memory device includes a virtual machine module for instantiating said virtual machine with an operating system on said host machine.

23. The process as claimed in claim 19, wherein said memory device is a portable device as claimed in claim 1.

24. A portable device for use in establishing trust, the portable device including:
a communications module for communicating with an untrusted computing system;
embedded trusted data;
a virtual machine module for instantiating a virtual machine on the untrusted computing system; and
a security module for including a secure application in said virtual machine to perform an attestation process using said embedded trust data to establish trust.

25-27. (canceled)
